(19) United States
(12) Patent Application Publication
(10) Pub. No.: US 2020/0028593 A1
(43) Pub. Date: Jan. 23, 2020

(54) OPTICAL COMMUNICATION CHANNEL EQUALIZATION USING A KERNEL

(71) Applicants: Jiajia CHEN, Sollentuna (SE); Lu ZHANG, Stockholm (SE); Xiaodan Pang, Stockholm (SE); Shilin Xiao, Minhang (CN)

(72) Inventors: Jiajia CHEN, Sollentuna (SE); Lu ZHANG, Stockholm (SE); Xiaodan Pang, Stockholm (SE); Shilin Xiao, Minhang (CN)

(21) Appl. No.: 16/038,658

(22) Filed: Jul. 18, 2018

(51) Int. Cl. H04B 10/69

(52) U.S. Cl. CPC H04B 10/6971

(57) ABSTRACT

The disclosure relates to a method performed by an optical receiver, the method comprising receiving an optical communication signal comprised in a signal space, the signal comprising a set of received training symbols and a set of received payload symbols, determining a kernel operating in a feature space by using the set of training symbols and a reference set of training symbols indicative of an undistorted version of the training symbols, wherein determining a kernel further comprises determining at least an equalization mapping function ƒ configured to map received symbols to channel equalized symbols, and determining an error function (e) configured to generate a measure indicative of an error between symbols mapped by the equalization mapping function ƒ and an ideal equalization mapping function, performing nonlinear equalization of the payload symbols (C′₁ to C′_{M}) by performing linear equalization of the payload symbols (C′₁ to C′_{M}) in the feature space using the received training symbols (C₁ to C_{N}) and the error function (e). The disclosure further relates to an optical receiver

### TECHNICAL FIELD

The present invention relates to a method performing nonlinear equalization in optical communication systems. The invention further relates to an optical receiver with corresponding computer program and computer program product.

### BACKGROUND

Nonlinear distortions to a transmitted signal are one of the major performance-limiting factors in high-speed optical communication systems.

Conventional systems typically use linear equalization methods to compensate channel distortions, e.g. least-mean-square (LMS), which cannot suppress the nonlinear distortions.

The conventional systems have tried to compensate the nonlinear distortions by using traditional adaptive nonlinear channel equalization schemes, e.g. Volterra equalization schemes.

A drawback with such conventional systems is that they require complex hardware design and rely on computationally complex methods.

Thus, there is a need for an improved method, optical receiver and optical modem.

### OBJECTS OF THE INVENTION

An objective of embodiments of the present invention is to provide a solution which mitigates or solves the drawbacks and problems of conventional solutions described above.

### SUMMARY OF THE INVENTION

The above and further objectives are achieved by the subject matter of the independent claims. Further advantageous implementation forms of the invention are defined by the dependent claims.

According to a first aspect of the invention, this objective is achieved by a method performed by an optical receiver, the method comprising receiving an optical signal in a signal space, and the signal comprising a set of received training symbols and a set of received payload symbols, determining a kernel operating in a feature space by using the set of training symbols and a reference set of training symbols indicative of an undistorted version of the training symbols, wherein determining a kernel further comprises determining at least an equalization mapping function ƒ configured to map received symbols to channel equalized symbols, and determining an error function e configured to generate a measure indicative of an error between symbols mapped by the equalization mapping function ƒ and undistorted version of the training symbols, performing nonlinear equalization of the payload symbols by performing linear equalization of the payload symbols in the feature space using the received training symbols and the error function. The disclosure further relates to an optical receiver.

At least one advantage of the disclosure according to the first aspect is that an improved channel equalization in an optical receiver can be achieved, in particular an improved nonlinear channel equalization. A further advantage is that computational complexity is reduced.

According to a second aspect of the invention, this objective is achieved by an optical receiver.

According to a third aspect of the invention, this objective is achieved by an optical modem.

Advantages of the second and third aspects are at least the same as the advantages for the first aspect.

Further applications and advantages of embodiments of the invention will be apparent from the following detailed description.

### BRIEF DESCRIPTION OF THE DRAWINGS

FIG. 1 shows an optical communication system according to one or more embodiments of the invention.

FIG. 2A shows signal distortion of a communication channel according to one or more embodiments of the invention.

FIG. 2B shows channel equalization performed according to one or more embodiments of the present disclosure.

FIG. 3 shows an example of a received signal according to one or more embodiments of the present disclosure.

FIG. 4 shows an example of mapping symbols from a signal space to kernel feature space according to one or more embodiments of the present disclosure.

FIG. 5 shows a schematic diagram of the proposed nonlinear equalization method according to one or more embodiments of the present disclosure.

FIG. 6 shows a block diagram of a method performed by an optical receiver according to one or more embodiments of the present disclosure.

FIG. 7 shows a block diagram of a method performed by an optical receiver according to one or more embodiments of the present disclosure.

FIG. 8 shows an optical receiver 130 according to one or more embodiments of the present disclosure.

A more complete understanding of embodiments of the invention will be afforded to those skilled in the art, as well as a realization of additional advantages thereof, by a consideration of the following detailed description of one or more embodiments. It should be appreciated that like reference numerals are used to identify like elements illustrated in one or more of the figures.

### DETAILED DESCRIPTION

An “or” in this description and the corresponding claims is to be understood as a mathematical OR which covers “and” and “or”, and is not to be understand as an XOR (exclusive OR). The indefinite article “a” in this disclosure and claims is not limited to “one” and can also be understood as “one or more”, i.e., plural.

The term “signal vector”, used herein, denotes a vector in signal space, typically representing a modulation symbol in a predefined signal constellation. An example of modulation is four level pulse amplitude modulation, PAM4.

In one aspect of the present disclosure, a nonlinear adaptive channel equalization method performed by an optical receiver for an optical communication system is presented. The method aims at compensating distortions, including linear and nonlinear distortions, for a signal transmitted over the optical communication system. The present disclosure make use of ‘kernel’ high-dimensional feature space mapping to map a received signal in low-dimensional signal space into kernel space or feature space, which is typically of a higher dimension. Nonlinear adaptive channel (post) equalization is then carried out at the optical receiver using the high-dimensional ‘kernel space’ mapped signals. By doing so, performance improvement can be achieved in high-speed optical communication systems. In other words, the proposed nonlinear adaptive channel equalization schemes utilize linear filtering mechanism in the high dimensional kernel space, e.g. induced by using a Mercer kernel, and can therefore be used for nonlinear channel equalization in an optical receiver, that requires low complexity and low computation complexity.

The present disclosure makes use of kernel methods, which are a new class of dimension mapping schemes. The disclosure uses Mercer kernels to produce nonlinear versions of conventional linear signal processing mechanisms. Kernel methods have the advantage to solve problems in higher dimensions that are difficult to be solved in lower dimensions. In other words, the solution to the problems may become easier or less complex when the processed data is mapped to a higher dimensional space. The inventors have made the realization, that merits of the kernel methods along with the mature linear adaptive filtering algorithms make kernel methods especially suitable for nonlinear adaptive equalization schemes in optical communications.

Consequently, the kernel method based nonlinear adaptive equalization method presented herein, in some embodiments follows the classic sequential learning rule of linear equalization structure, whilst changing the coefficients configuration functions. From a computational point of view, when the proposed kernel based nonlinear adaptive equalization is properly defined, the computational complexity of working in high-dimensional space or feature space of the kernel will be reduced.

Since the performance of optical communication systems or networks is typically limited by signal distortions, especially nonlinear signal distortions, the proposed method can solve this challenge in an effective way, and help to improve the optical communications.

The main factors that hinder the improvement and capacity of high speed optical communication system are the power fading from fiber chromatic dispersion, nonlinearities such as the fiber nonlinearity, nonlinearities from optical modulator, electrical driver amplifier noise and the square-law detection from the photo detector. While the chromatic dispersion can be easily compensated by the optical dispersion compensation fiber (DCF) or single side-band (SSB) modulation, nonlinearities have become an ever more important issue, which influences the performance of high speed optical communications.

Recently, the research community has put tremendous efforts to develop digital signal processing (DSP) strategies in optical communication systems. Since low-complexity linear DSP equalization algorithms, such as least-mean-square (LMS) cannot perform properly to mitigate the system nonlinear distortions, nonlinear DSP equalization schemes, such as prototype filtering schemes (e.g. Volterra filtering scheme), machine learning based schemes (e.g. k-nearest neighbor, support vector machine) have been proposed to further improve the performance of optical communications. However, the high computational complexity of these nonlinear equalization schemes becomes one important concern of optical communication systems.

In the present disclosure, we present a nonlinear adaptive channel equalization scheme performed by a receiver for optical communication systems. The proposed nonlinear adaptive equalization method mitigates nonlinear signal distortions in the optical communication systems. It has the advantage of improved system performance in terms of bit-error-ratio, computational complexity and processing latency. It is therefore promising in high speed optical communication systems.

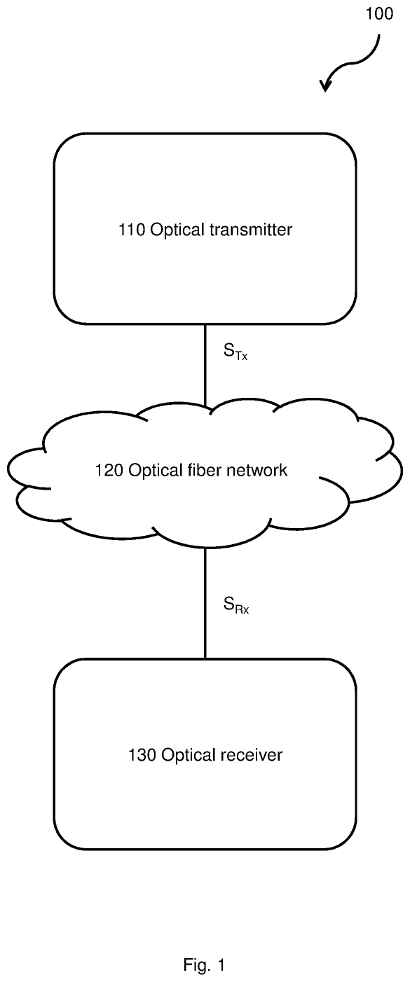

FIG. 1 shows an optical communication system 100 according to one or more embodiments of the invention. The optical communication system 100 comprises an optical fiber network 120, e.g. comprising optical fibers, amplifiers, regenerative signal equipment etc. The optical communication system 100 further comprises an optical transmitter 110, e.g. an optical transceiver, configured to transmit an optical signal S_{Tx} over the optical fiber network 120. The optical communication system 100 further comprises an optical receiver 130, e.g. an optical transceiver, configured to receive an optical signal S_{Rx} from the optical fiber network 120.

The optical transmitter 110 and/or the optical receiver 130 may be transceivers using any of Ethernet, Fiber Channel, InfiniBand, Synchronous optical networking (SONET), synchronous digital hierarchy (SDH), Optical Transport Network (OTN), Common Public Radio Interface (CPRI) and Common Public Radio Interface (PON) technology.

When the optical signal S_{Tx} is transmitted over the optical fiber network 120, it will be distorted and received by the optical receiver 130 as the optical signal S_{Rx}. The optical receiver 130 will then attempt to reduce or mitigate the signal distortion by performing channel equalization, as further described below.

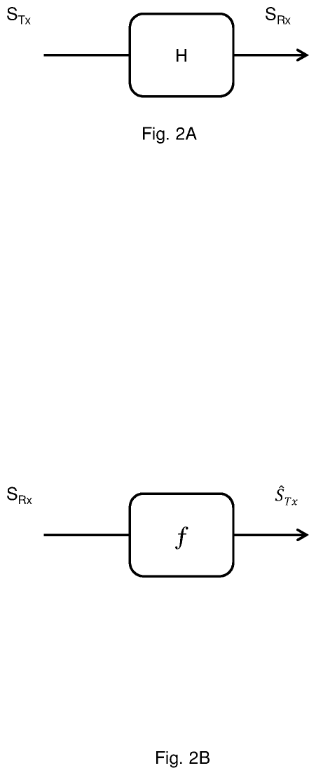

FIG. 2A shows signal distortion of a communication channel according to one or more embodiments of the invention. An optical signal S_{Tx} is transmitted by the optical transmitter 110 over the optical fiber network 120. The optical signal S_{Tx} is transmitted over a channel H or transfer function of the optical fiber network 120, thereby being subjected to a distortion caused by the channel H. The optical receiver 130 then receives the distorted transmitted optical signal S_{Tx} as the optical signal S_{Rx}.

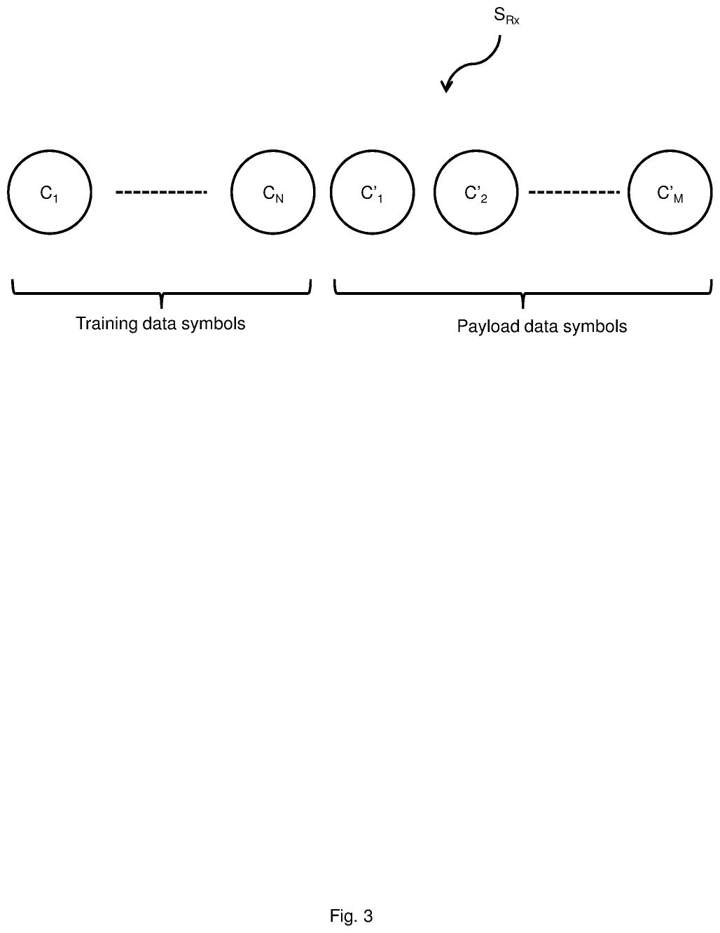

In one example, the transmitted signal S_{Tx} may e.g. comprise training signal vectors X₁ to X_{N} and payload signal vectors X′₁ to X′_{M}, as further detailed in relation to FIG. 3. The received signal S_{Rx} may comprise distorted transmitted training signal vectors C₁ to C_{N} and payload signal vectors C′₁ to C′_{M}.

FIG. 2B shows channel equalization performed according to one or more embodiments of the invention. The optical receiver 130 may further perform channel equalization on the received signal S_{Rx} by applying an equalization mapping function/equalization function mapping ƒ to obtain a channel equalized signal Ŝ.

In one example, the received signal S_{Rx} comprises the distorted training signal vectors C₁ to C_{N} and payload signal vectors C′₁ to C′_{M}, and the channel equalized signal Ŝ comprises channel equalized training signal vectors Ĉ₁ to Ĉ_{N} and channel equalized payload signal vectors to Ĉ′₁to Ĉ′_{M}.

In one embodiment, the equalization mapping function ƒ is determined by:

Step a) obtaining an initial equalization mapping function ƒ and/or an initial set of kernel parameters defining/generating the kernel,

Step b) obtaining termination criteria,

Step c) determining an updated set of kernel parameters and/or an updated equalization function mapping ƒᵢ by performing an iteration step, and

repeating step c) until the termination criteria are fulfilled.

In one embodiment, a measure and/or error function e indicative of an error relative an ideal mapping to equalized map training symbols and data symbols is further determined.

In other words, the equalization function mapping f is determined by performing a plurality of iterative steps. The termination criteria may be based on a certain number of iteration steps and/or the measure and/or the error function e. In one example, the iteration may e.g. be terminated after a certain number of iteration steps have been performed and/or when the measure and/or the result of the error function e is below a threshold value, e.g. the value 1e-7.

FIG. 3 shows an example of a received signal S_{Rx} according to one or more embodiments of the invention. The received signal S_{Rx} may comprise a set of received training signal vectors C₁ to C_{N} and a set of received payload signal vectors C′₁ to C′_{M}.

As described further in relation to FIG. 2A, the received training symbols C₁ to C_{N} and the received payload signal vectors C′₁ to C′_{M} may be distorted versions of ideal transmitted training signal vectors X₁ to X_{N} and ideal transmitted payload signal vectors X′₁ to X′_{M} sent over the channel H. In embodiments described herein, the transmitted training symbols and the received training symbols may be used to determine the equalization mapping function ƒ. In embodiments described herein, the transmitted training symbols and the received training symbols may be used to determine the characteristics of the channel H, e.g. by determining a transfer function and or an inverse channel transfer function or channel equalization function

$$\frac{1}{H}$$

(not shown in the figure).

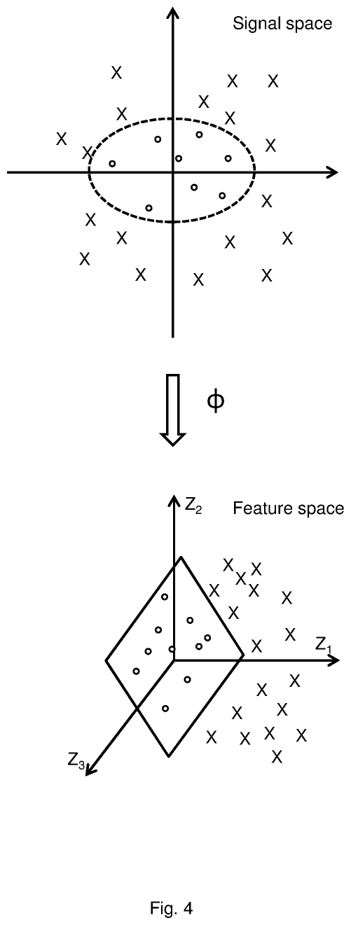

FIG. 4 shows an example of mapping symbols from a signal space to kernel feature space according to one or more embodiments of the invention. In the example, training signal vectors C₁ to C_{N} are received comprised in the received signal S_{Rx} which is received in a two-dimensional signal space. The training signal vectors C₁ to C_{N} are shown as circles. Further in the example, payload signal vectors C′ are received comprised in the received signal S_{Rx} which is received in a two-dimensional signal space. The payload signal vectors C′₁ to C′_{M} are shown as the letter “x” in the figure. In embodiments, a feature-mapping function φ may be defined and configured to map received training signal vectors C₁ to C_{N} and received payload signal vectors C′₁ to C′_{M} from the two-dimensional signal space to the three-dimensional (kernel) feature space. In this particular example, the training symbols are mapped onto a plane or hyperplane.

In one aspect of the disclosure, channel equalization is performed using linear filtering mechanisms in the high dimensional space induced by the kernel, e.g. a Mercer kernel. Examples of such using linear filtering mechanisms are least mean square (LMS), recursive least squares (RLS) and minimum mean square error (MMSE). It is understood that the present disclosure can be expanded to any other linear filtering mechanisms in the art. This ensures an improved channel equalization and can therefore be used for nonlinear channel equalization with low computation complexity from linear filtering mechanism.

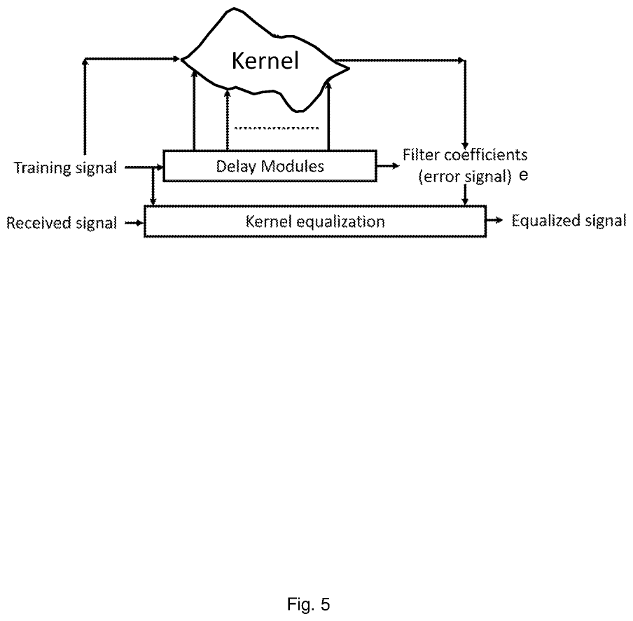

FIG. 5 shows a schematic diagram of the proposed nonlinear equalization method according to one or more embodiments of the invention. As can be seen from FIG. 5, the proposed nonlinear equalization method follows a classic sequential filtering scheme for linear equalization, whilst using a kernel, e.g. a Mercer kernel, as input signal equalization mapping function ƒ.

A Mercer kernel ϑ( [symbol] ) is a continuous and symmetric basis function defined in the kernel

Hilbert space. In this disclosure, a Gaussian kernel is used as a dominant expression of ϑ( [symbol] ):

ϑ( [symbol] )=exp (−α∥ [symbol] )∥²) EQ (1)

where \vec{c} is the training signal vector, \vec{c}′40 is the received or measured payload signal vector, and α is the Gaussian kernel bandwidth, which is typically a normalized constant parameter from 0 to 1.

Without loss of generality, it is foreseen that other types of kernels can also be utilized here, such as polynomial kernel, extended Gaussian kernel. It is understood that the present disclosure is not limited to the above mentioned kernels, and any suitable kernel may be used according to the present disclosure.

According to the Schölkopf representor theorem, the classic linear sequential processing, such as minimum mean square error (MMSE), has the universal approximation property for any continuous mapping function ƒ in kernel Hilbert space. The corresponding mapping function ƒ can be expressed as:

ƒ=Σᵢ₌₁^{N}aᵢϑ(·, [symbol] (i)), EQ (2)

where N represents the number of training symbols and/or samples, and aᵢ is a coefficient, e.g. a predefined constant coefficient.

According to EQ(2), the inventors realized that the equalization function mapping/mapping function ƒ can always be expressed in terms of the training signal vectors \vec{c} when using a Mercer kernel. Therefore, an important concept of the disclosure, namely of employing kernel method in nonlinear channel equalization, comprises:

1) to transform the input data into a high-dimensional space by employing EQ(1)-EQ(2), and

2) to apply an appropriate linear algorithm to process the inner product of the transformed input data and training data.

In embodiments, EQ(1) can be expanded as:

ϑ( [symbol] )=Σᵢ₌₁^{∞}εᵢθᵢ( [symbol] )θᵢ( [symbol] ) EQ (3)

where εᵢ and θᵢ are a non-negative eigenvalue and eigenfunction, respectively. A feature-mapping function or mapping φ may be denoted as a set of the eigenfunctions:

φ( [symbol] )=[\sqrt{ε₁}θ₁( [symbol] ), \sqrt{ε₂}θ₂( [symbol] ), . . . ] EQ (4)

φ is the feature mapping function from signal space to kernel feature space and φ(\vec{c}) is the transformed feature vector in the kernel feature space. As a result, EQ (1) can be expressed as:

ϑ( [symbol] )=φ( [symbol] )^{T}φ( [symbol] ) EQ (5)

In the nonlinear equalization method proposed herein, the training signal vectors e is transformed into φ(\vec{c}), which is then applied to a classic linear equalization mechanism, such as least-mean-square (LMS).

In one example, a least-mean-square (LMS) channel equalization scheme is used:

The i-th iteration of the proposed nonlinear equalization method can then be expressed as:

$$\{ \begin{matrix}e ( i ) = x ( i ) - {{h}^{r} ( i - 1 )}^{T} ϕ ( {c}^{r} ( i ) ) \\ {h}^{r} ( i ) = {h}^{r} ( i - 1 ) + μ e ( i ) ϕ ( {c}^{r} ( i ) ) ,\end{matrix} \qquad EQ ( 6 )$$

where x(i) is the desired or ideal training signal, e(i) is the predicted channel equalization error, \vec{h}(i) is the estimated filter weight vector, and μ is the step-size parameter. In other words, the e(i) indicates a measure of how much the channel equalized training symbols channel equalized training signal vectors Ĉ₁ to Ĉ_{N} differs from the ideal training symbols/transmitted training signal vectors X₁ to X_{N}.

By expanding the weight vector in EQ(6) iteratively, we can get:

$$\begin{matrix}{h}^{r} ( i ) = {h}^{r} ( i - 1 ) + μ e ( i ) ϕ ( {c}^{r} ( i ) ) \\ = {h}^{r} ( i - 2 ) + μ ( e ( i - 1 ) ϕ ( {c}^{r} ( i - 1 ) ) + μ e ( i ) ϕ ( {c}^{r} ( i ) ) ) \\ … \\ = {h}^{r} ( 0 ) + μ {\sum }_{j = 1}^{i} e ( j ) ϕ ( {c}^{r} ( j ) ) \\ = μ {\sum }_{j = 1}^{i} e ( j ) ϕ ( {c}^{r} ( j ) ) ( Assuming {h}^{r} ( 0 ) = 0 )\end{matrix} \qquad EQ ( 7 )$$

Thus, it can be realized that after the i-th iteration step, the estimated filter weight vector is expressed as a linear combination of all the previous and present (transformed) inputs, multiplied by the predicted errors or error function e.

The inventors realized that \vec{h}(i) does not appear in the right side of EQ(7). Instead, the sum of all past errors multiplied by the transformed feature vector of the previously received data (training data or symbols).

Therefore, the presend disclosure has the advantage to reduce computational complexity as the channel equalization can be performed by a single inner product. This saves a huge amount of computation resources and/or time for nonlinear equalization in optical communication systems.

Assuming ƒₖ is the channel equalization mapping function at the k-th iteration, the proposed nonlinear equalization method can then be expressed as:

ƒₖ(\vec{c}(j))=μΣⱼ₌₁ⁱ⁻¹e(i)ϑ(\vec{c}(j), \vec{c}(i)), EQ (8)

where the equalization mapping function ƒₖ₋₁ is configured to map received symbols to channel equalized symbols, j is the index of c and i is the index or indicia of the training symbol.

An error can be defined as:

e(i)=x(i)−fₖ₋₁(\vec{c}(i)) EQ (9)

where e is the measure and/or the error function e indicative of an error relative an ideal mapping to equalized symbols, x is an ideal or undistorted training symbol. In other words, an ideal mapping to equalized symbols would map received symbols/vectors to the corresponding transmitted signal vectors, e.g. X₁ to X_{N}.

ƒₖ(⋅)=ƒₖ₋₁(⋅)+μe(i)ϑ(\vec{c}(i);) EQ (10)

where fₖ is the equalization mapping function of iteration k, ƒₖ₋₁(⋅) is the equalization mapping function of the previous iteration, μ is the iteration step parameter to control the convergence speed, which is a constant parameter from 0 to 1, and ϑ is the kernel, e.g. a Gaussian kernel as defined by EQ (1).

In other words, EQ (8) is the equalization mapping function, EQ (9) is the error function e and EQ (10) is the updating function or the updated equalization mapping function. The proposed nonlinear equalization filter taps (i.e. the dimension or the length of vector c) of the equalization mapping function may be equal to the number of dimensions of \vec{c}., in other words the number of dimensions of the kernel feature space

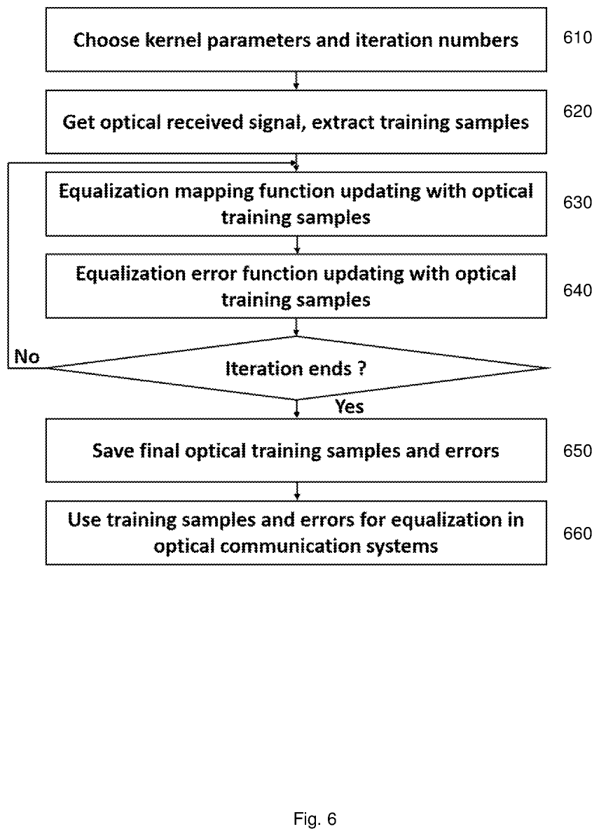

FIG. 6 shows a block diagram of a method performed by an optical receiver according to one or more embodiments of the present disclosure.

In the first step 610, which is optional, a set of parameters are obtained, e.g. parameters defining the kernel ϑ and termination criteria, e.g. a number of desired or maximum iterations. The set of parameters may be obtained from memory or received from another node in the optical communication network 120.

In one example, when using a kernel or kernel function, there are some parameters that need to be defined in the set of parameters before the kernel may be used, e.g. the Gaussian kernel function bandwidth α. In addition, the number of iterations or the number of equalization mapping function optimization iterations needs to be defined in the set of parameters, e.g. setting the number of iterations equal to 1000, whereby the equalization mapping function optimization ends at the 1001-th iteration). In addition, initial parameters for equalization optimization, such as the step size μ may be defined in the set of parameters. In addition, the result or value of the error function e or error signal at the 0-th iteration, i.e. e(0)=0, may be defined in the set of parameters.

An optical communication signal S_{Rx}, may be or has already been received by the receiver. The optical communication signal S_{Rx} may be comprised in a signal space and comprise any of a set of received training signal vectors C₁ to C_{N}, a set of received/measured payload signal vectors C′₁ to C′_{M}, as further described in relation to FIG. 3. The received training symbols C₁ to C_{N} and the set of measured/received payload signal vectors C′₁ to C′_{M} include channel distortion from a channel H used to transmit the signal S_{Tx} over the optical communications network 120.

In the second step 620, one or more received training signal vector(s) C₁ to C_{N} and one or more received/measured desired payload signal vector(s) C′₁ to C′_{M}, including channel distortion from the channel H, is extracted from the received signal S_{Rx}. The content of the received signal S_{Rx} is further described in relation to FIG. 3. In other words, the method step 620 comprises receiving an optical signal S_{Rx} consisting of training signal vector(s) C₁ to C_{N}and received/measured data/payload symbol(s) C′₁ to C′_{M}.

The received signal S_{Rx}, may in the initial samples/symbols comprise the distorted training signal vector(s) C₁ to C_{N} and in the following samples/symbols comprise payload signal vector(s) C′₁ to C′_{M}. For the training signal vector(s) C₁ to C_{N} we know the corresponding transmitted ideal symbol or desired symbol(s) X₁ and X₂, since they may be predefined or signaled from the transmitter 110. Thus, the training symbol/s only, are used for channel equalization optimization. For the measured/received payload signal vector(s) C′₁ to C′_{M}, which are the symbols that carry information, we do not know the ideal symbols X′₁ to X′_{M} symbol/signal vectors at the receiver, and we need the channel equalization method proposed by this disclosure to recover the transmitted information, e.g. the transmitted ideal symbol or desired payload symbol(s) C′₁ to C′_{M}.

In the step 630, the equalization mapping function ƒ using the training signal vectors C₁ to C_{N} are updated according to EQ (8) at the i-th iteration.

In the step 640, the predicted channel equalization error/error signal e(i) is updated according to EQ (9), which is the difference between (desired signal d) ideal training symbol x(i) and the result of EQ (8) at the i-th iteration. In other words, the predicted channel equalization error e(i) indicates a measure of how the determined equalization mapping function at iteration i ƒᵢdiffers from an ideal equalization mapping function ƒ or how much the channel equalized training symbols channel equalized training vectors or symbols Ĉ₁ to \vec{C_{N}} differs from the ideal training symbols/transmitted training signal vectors or symbols X₁ to X_{N}.

If the termination criteria are not fulfilled, e.g. the iteration number is smaller than the predefined number of iterations obtained in the step 610, go back to the step 630 and the iteration number is added by 1. Otherwise, the method proceeds to step 650.

In the step 650, which is optional, the error signal e and corresponding training signal c is stored, e.g. in memory. In the step 660, channel equalization is performed using the predicted channel equalization error/error signal e and training signal vectors C₁ to C_{N} from step 650 to equalize the measured signal c′ with

ƒₖ₋₁(ĉ′)=μΣⱼ₌₁^{L}e(j)ϑ(\vec{c}(j), \vec{c}′)

As mentioned before and without loss of generality, other types of classic linear equalization mechanism may be used herein, such as recursive least squares (RLS), minimum mean square error (MMSE). By mapping the received signal \vec{c} into feature space φ(\vec{c}), these linear equalization schemes can be modified to operate as the proposed nonlinear adaptive equalization scheme.

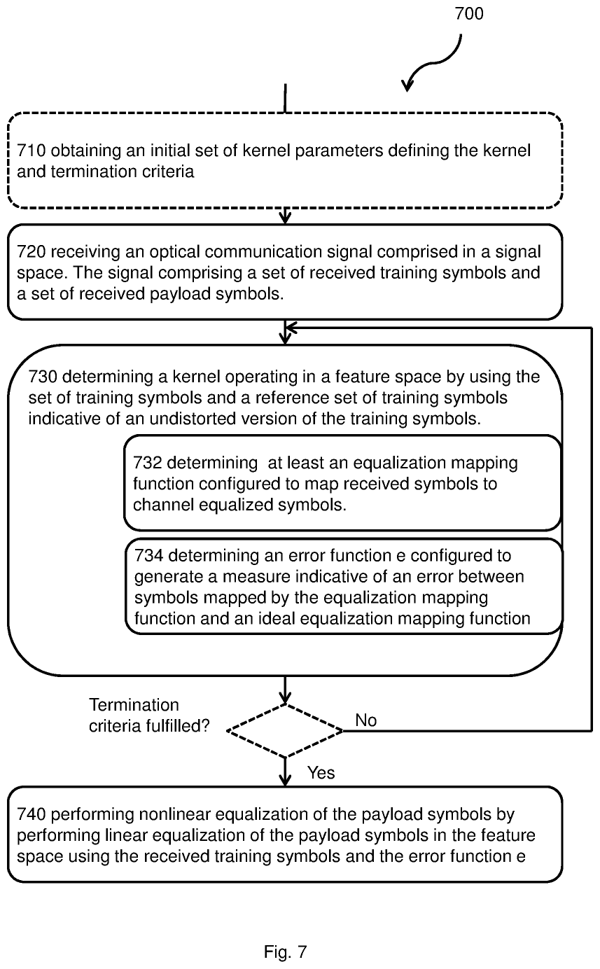

FIG. 7 shows a block diagram of a method 700 performed by an optical receiver according to one or more embodiments of the present disclosure. The method 700 comprises:

Optional step 710: obtaining an initial set of kernel parameters defining the kernel and termination criteria. This may be performed in a similar manner to what is described in relation to the step 610 in FIG. 6.

Step 720: receiving an optical communication signal S_{Rx} comprises a signal space. The signal S_{Rx} comprising a set of received training symbols C₁ to C_{N} and a set of received payload symbols C′₁ to C′_{M}. This can be performed in a similar manner to what is described in relation to the step 620 in relation to FIG. 6.

Step 730: determining a kernel operating in a feature space by using the set of training symbols C₁ to C_{N} and a reference set of training symbols X₁ to X_{N} indicative of the undistorted training symbols. The feature space is of a higher dimension than the dimension of the signal space, as further described in relation to FIG. 4. Determining a kernel may further comprise defining/generating a kernel using a set of kernel parameters, e.g. the initial set of kernel parameters or an updated set of kernel parameters.

In one embodiment, determining a kernel further comprises the steps:

Step 732: determining at least an equalization mapping function ƒ of the kernel configured to map the received symbols to channel equalized symbols.

Step 734: determining an error function e configured to generate a measure indicative of an error between symbols mapped by the equalization mapping function ƒ and an ideal equalization mapping function.

The steps 730, 732 and 734 may be performed in a similar manner as the steps 630 and 640 described in relation to FIG. 6.

In one example of the step 732, the equalization mapping function ƒ is determined as an initial equalization mapping function ƒ₀ or as an updated equalization mapping function ƒᵢ according to EQ (8) at the i-th iteration as further described in relation to EQ(8) to EQ(10).

In one example of the step 734, the predicted channel equalization error/error signal e(i) is updated according to EQ (9), which is the difference between the ideal training symbol x(i) and the result of Eq. 8 at i-th iteration as further described in relation to EQ(8) to EQ(10).

if the termination criteria are not fulfilled, the method comprises performing a further iteration step, i.e. repeating steps 732 and 734 by generating an updated equalization mapping function ƒ and an updated error function e as further described in relation to EQ(8) to EQ(10).

if the termination criteria are fulfilled, the method further comprises:

Step 740: performing nonlinear equalization of the payload symbols C′₁ to C′_{M} by performing linear equalization of the payload symbols C′₁ to C′_{M} in the feature space using the received training symbols C₁ to C_{N} and the error function e. In one example, nonlinear equalization is performed using the updated equalization mapping function ƒᵢ defined in EQ(8)

In one embodiment, the kernel is a Mercer kernel.

In one embodiment, the nonlinear equalization is performed using Least Mean Square equalization defined by the relation in EQ(6)

In one embodiment, an optical receiver is provided comprising processing circuitry and configured to perform any of the method steps described herein.

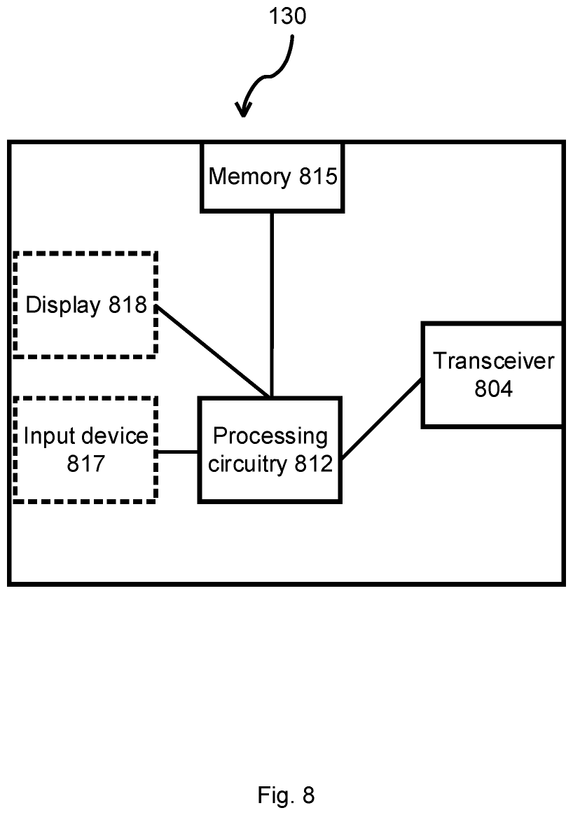

FIG. 8 shows an optical receiver 130 according to one or more embodiments of the present disclosure. The optical receiver 130 may be in the form of a selection of any of an optical modem, a server or a computer. The optical receiver 130 may comprise processing circuitry 812, such as a processor, communicatively coupled to a communication interface/transceiver 804 configured for optical communication. The processing circuitry 812 is configured to perform any of the method steps described herein. In one example, the processing circuitry 812 may be any of a selection of processing circuitry and/or a central processing unit and/or processor modules and/or multiple processors configured to cooperate with each other. Further, the optical receiver 130 may further comprise a memory 815. The memory 815 may contain instructions executable by the processing circuitry to perform the methods described herein. The processing circuitry 812 may be communicatively coupled to a selection of any of the transceiver 804 and the memory 815.

The optical receiver 130 may further comprise a communication interface, e.g. the transceiver 804, which is configured to send and/or receive data values or parameters as a signal to or from the processing circuitry 812 to or from other external nodes, e.g. a second optical modem. In an embodiment, the communication interface communicates directly between communication network nodes or via the communications network 120.

In one or more embodiments the optical receiver 130 may further comprise an input device 817, configured to receive input or indications from a user and send a user-input signal indicative of the user input or indications to the processing circuitry 812.

In one or more embodiments the receiver 130 may further comprise a display 818 configured to receive a display signal indicative of rendered objects, such as text or graphical user input objects, from the processing circuitry 812 and to display the received signal as objects, such as text or graphical user input objects.

In one embodiment the display 818 is integrated with the user input device 817 and is configured to receive a display signal indicative of rendered objects, such as text or graphical user input objects, from the processing circuitry 812 and to display the received signal as objects, such as text or graphical user input objects, and/or configured to receive input or indications from a user and send a user-input signal indicative of the user input or indications to the processing circuitry 812. In embodiments, the processing circuitry 812 is communicatively coupled to the memory 815 and/or the communication interface 804 and/or the input device 817 and/or the display 818.

In embodiments, the communication interface and/or transceiver 804 communicates using optical communication techniques, e.g. over an optical fiber. In embodiments, the one or more memory 815 may comprise a selection of a hard RAM, disk drive, a floppy disk drive, a magnetic tape drive, an optical disk drive, a CD or DVD drive (R or RW), or other removable or fixed media drive.

In one embodiment, a computer program is provided comprising computer-executable instructions for causing an optical receiver, when the computer-executable instructions are executed on processing circuitry comprised in the optical receiver, to perform any of the method steps described herein.

In one embodiment, a computer program product comprising a computer-readable storage medium, the computer-readable storage medium having the computer program above embodied therein.

In one embodiment, a carrier containing the computer program above, wherein the carrier is one of an electronic signal, optical signal, radsignal, or computer readable storage medium.

Processing circuitry is configured to perform any determining, calculating, or similar operations (e.g., certain obtaining operations) described herein as being provided by an optical modem. These operations performed by processing circuitry may include processing information obtained by processing circuitry by, for example, converting the obtained information into other information, comparing the obtained information or converted information to information stored in the optical modem, and/or performing one or more operations based on the obtained information or converted information, and as a result of said processing making a determination.

Processing circuitry may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network nodes components, such as device readable medium, optical modem functionality. For example, processing circuitry may execute instructions stored in device readable medium or in memory within processing circuitry. Such functionality may include providing any of the various wireless features, functions, or benefits discussed herein. In some embodiments, processing circuitry may include a system on a chip (SOC).

In some embodiments, processing circuitry may include one or more of optical transceiver circuitry and baseband processing circuitry. In some embodiments, optical transceiver circuitry and baseband processing circuitry may be on separate chips (or sets of chips), boards, or units. In alternative embodiments, part or all of optical transceiver circuitry and baseband processing circuitry may be on the same chip or set of chips, boards, or units

Finally, it should be understood that the invention is not limited to the embodiments described above, but also relates to and incorporates all embodiments within the scope of the appended independent claims.

1. A method performed by an optical receiver, the method comprising:
receiving an optical communication signal comprised in a signal space, the signal comprising a set of received training symbols and a set of received payload symbols
determining a kernel operating in a feature space by using the set of training symbols and a reference set of training symbols indicative of undistorted training symbols, wherein determining a kernel further comprises:
determining at least an equalization mapping function ƒ configured to map received symbols to channel equalized symbols, wherein the received symbols comprise the set of received training symbols and the set of received payload symbols, and
determining an error function configured to generate a measure indicative of an error between the channel equalized symbols and ideal symbols, wherein the received symbols is mapped to the ideal symbols through an ideal equalization mapping function,
performing nonlinear equalization of the payload symbols by performing linear equalization of the payload symbols in the feature space using the received training symbols and the error function;
wherein the nonlinear equalization is performed using Least Mean Square equalization defined by a relation:
$$\{ \begin{matrix}e ( i ) = x ( i ) - {\vec{h} ( i - 1 )}^{T} ϕ ( \vec{c} ( i ) ) \\ \vec{h} ( i ) = \vec{h} ( i - 1 ) + μ e ( i ) ϕ ( \vec{c} ( i ) ) ,\end{matrix}$$
where x(i) is an ideal training signal, e(i) is the error function, \vec{h} (i) is an channel equalization filter weight vector, μ is a step-size parameter, φ(\vec{c}(i)) is a feature mapping function from the signal space to a kernel feature space, and \vec{c}(i) is a training signal vector.

2. The method according to claim 1, wherein method further comprises:
obtaining an initial set of kernel parameters defining the kernel and termination criteria, and
if the termination criteria are not fulfilled, to further determining an updated set of kernel parameters by performing an iteration step.

3. The method according to claim 1, wherein the kernel is a Mercer kernel.

4. (canceled)

5. An optical receiver comprising processing circuitry and configured to perform the method according to claim 1.

6. An optical modem comprising the optical receiver according to claim 5.

7. (canceled)

8. A computer program product comprising a non-transitory computer-readable storage medium, the computer-readable storage medium having a computer program embodied therein, wherein the computer program comprises computer-executable instructions, when being executed on processing circuitry comprised in an optical receiver, causing the optical receiver to perform the method according to claim 1.

9. A non-transitory computer readable storage medium having a computer program, wherein the computer program comprises computer-executable instructions, when being executed on processing circuitry comprised in an optical receiver, causing the optical receiver to perform the method according to claim 1.
